(19) United States
(12) Patent Application Publication
(10) Pub. No.: US 2004/0076873 A1
(43) Pub. Date: Apr. 22, 2004

(54) Rechargeable battery

(76) Inventor: Chih-Jung Chiu, Taoyuan (TW)

Correspondence Address: BIRCH STEWART KOLASCH & BIRCH, PO BOX 747, FALLS CHURCH, VA, 22040-0747, US

(21) Appl. No.: 10/424,782

(22) Filed: Apr. 29, 2003

(30) Foreign Application Priority Data
Oct. 16, 2002 (TW) 091216476

(51) Int. Cl. H01M 2/12; H01M 2/08; H01M 2/38

(52) U.S. Cl. 429/72; 429/185; 429/89; 429/80

(57) ABSTRACT

A rechargeable battery allowing replenishment of electrolytes and a safety vent therefor. The battery includes a metal jacket, a positive electrode, a negative electrode, a cover, a base, a sealing member, and a compressing member. The metal jacket is filled with electrolytes. The positive electrode and the negative electrode are disposed in the metal jacket and immersed in the electrolytes. The cover has an opening therein and connects to the metal jacket. The cover and the metal jacket encase the positive electrode and the negative electrode. The base has a through-hole and an exhaust communicating therewith. The through-hole communicates with the opening of the cover. The sealing member is disposed in the through-hole. The compressing member is disposed in the through-hole. The compressing member presses the sealing member to seal the opening of the cover.

### BACKGROUND OF THE INVENTION

1. Field of the Invention

The present invention relates in general to a rechargeable battery. In particular, the present invention relates to a rechargeable battery allowing replenishment of electrolytes therein to restore chemical reaction.

2. Description of the Prior Art

FIG. 1a, FIG. 1b, FIG. 1c and FIG. 1d depict a conventional rechargeable Ni—H battery. FIG. 1a is a cross section of a conventional rechargeable Ni—H battery; FIG. 1b is a perspective exploded diagram showing a safety vent in a conventional rechargeable Ni—H battery; FIG. 1c is a perspective diagram showing a safety vent in a conventional rechargeable Ni—H battery; and FIG. 1d is a cross section along IC-IC′ section line of FIG. 1c.

FIG. 1a shows a conventional rechargeable Ni—H battery. The Ni—H battery comprises a safety vent 10, a metal jacket 11, an insulating gasket 12, a positive electrode 13, a dividing plate 14, and a negative electrode 15. The positive electrode 13, the dividing plate 14 and the negative electrode 15 are cylindrical and coaxially arranged within the metal jacket 11.

In a conventional rechargeable Ni—H battery, a positive electrode is NiO, a negative electrode comprises Hydrogen Storage Alloys (HSA), and electrolytes are basic solutions such as KOH. The positive electrode and the negative electrode are immersed in the electrolytes. Chemical reactions occur within the battery as follows:

positive: Ni(OH)₂+OH⁻⇄NiOOH+H₂O+e⁻

negative: M+H₂O+e⁻⇄Mhab+OH⁻

battery: Ni (OH)₂+M⇄NiOOH+Mhab

M:HSA Mhab:metal oxide

In the Ni—H battery mentioned above, when the battery discharges, an oxidation reduction reaction occurs between the positive electrode and the negative electrode. The electrons transfer through an external circuit to produce an electric current. Inside the battery, charged ions transfer between the positive electrode and the negative electrode. The HSA is charged within the electrolytes, and electrochemical reactions occur at a surface of the HSA. Hydrogen dissociated from water moves on the surface of the HSA, and then diffuses and dissolves within the HSA. Hydrogen reacts with the HSA to form a metal oxide and release reaction heat.

FIG. 1b shows the safety vent in FIG. 1a. A safety vent 10 of the rechargeable Ni—H battery mentioned above comprises a cover 102, a seal 104, a metal lid 106, and exhaust passages 110. The cover 102 has an opening 112, the metal lid 106 is a regular positive electrode of a battery, and exhaust passages 110 are disposed around the metal lid 106. When a chemical reaction occurs in the battery, rapid rate of reaction sometimes results in high pressure. The exhaust passages balance the inner pressure of the battery.

Referring to FIG. 1c and FIG. 1d, during assembly of the safety vent 10, the metal lid 106 connects to the cover 102, and the seal 104 is placed in the metal lid 106. The seal 104 in the opening 112 of the cover 102 provides an enclosed space therein. The exhausted pressure value of the safety vent 10 varies with the compression of the seal 104.

In use, the Ni—H battery is charged and discharged, during which, water in the electrolytes decomposes to Hydrogen (H₂) and Oxygen (O₂), via the following formula.

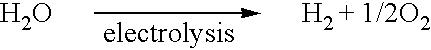

In the above reaction, hydrogen easily exhausts from the safety vent 10, and the oxygen reacts with an active substance in the negative electrode 15 to form an oxide. Thus, the hydrogen and the oxygen cannot combine to form water (H₂O), and the water is gradually dissipated. As a result, the chemical reaction cannot effectively take place within the battery. Performance, electrolyte volume, and lifetime of the battery are all thus reduced, requiring replacement of the battery.

### SUMMARY OF THE INVENTION

An object of the present invention is to provide a safety vent for a rechargeable battery that, when water in the electrolytes dissipates, allows replenishment thereof. Chemical reaction renews within the battery and as a result, lifetime of the battery is extended.

The present invention provides a rechargeable battery allowing replenishment of electrolytes. The battery comprises a metal jacket, a positive electrode, a negative electrode, a cover, a base, a sealing member, and a compressing member. The metal jacket has electrolytes therein. The positive electrode and the negative electrode are both disposed in the metal jacket and immersed in the electrolytes. The cover has an opening therein and connects to the metal jacket. The cover and the metal jacket enclose the positive electrode and the negative electrode. The base has a through-hole and an exhaust communicating therewith, and the through-hole communicates with the opening of the cover. The sealing member and the compressing member are both disposed in the through-hole. The compressing member presses the sealing member to seal the opening of the cover.

The present invention also provides a second design for a rechargeable battery allowing replenishment of electrolytes. The battery comprises a metal jacket, a positive electrode, a negative electrode, a cover, a base, a sealing member and a screw. The metal jacket has electrolytes therein. The positive electrode and the negative electrode are both disposed in the metal jacket and immersed in the electrolytes. The cover has an opening therein and connects to the metal jacket. The cover and metal jacket enclose the positive electrode and the negative electrode. The base has an opening, a threaded opening, and an exhaust passage. The base connects to the cover. The opening communicates with the opening of the cover, the threaded opening, and the exhaust passage. The sealing member is disposed in the through-hole. The screw engages with the threaded opening of the base, and the screw compresses the sealing member to seal the opening of the cover.

The present invention finally provides a third design for a rechargeable battery allowing replenishment of electrolytes. The battery comprises a metal jacket, a positive electrode, a negative electrode, a cover, a base, a first sealing member, a second sealing member and a fastener. The metal jacket has electrolytes therein. The positive electrode and the negative electrode are both disposed in the metal jacket and immersed in the electrolytes. The cover has a first and second opening and connects to the metal jacket. The cover and the metal jacket enclose the positive electrode and the negative electrode. The base has an opening and an exhaust communicating therewith and connects to the cover. The opening communicates with the first opening. The first sealing member is disposed in the opening to seal the first opening. The fastener connects to the cover, and the fastener fixes the second sealing member to seal the second opening of the cover.

### DESCRIPTION OF THE DRAWINGS

The present invention can be more fully understood by reading the subsequent detailed description in conjunction with the examples and references made to the accompanying drawings, wherein:

FIG. 1a is a cross section of a conventional rechargeable Ni—H battery;

FIG. 1b is a perspective exploded diagram showing a safety vent in a conventional rechargeable Ni—H battery;

FIG. 1c is a perspective diagram showing a safety vent in a conventional rechargeable Ni—H battery;

FIG. 1d is a cross section along IC-IC′ section line of FIG. 1c;

FIG. 2a is a cross section showing a rechargeable battery allowing replenishment of electrolytes of the present invention;

FIG. 2b is a perspective exploded diagram showing a safety vent according to the present invention;

FIG. 2c is a perspective diagram showing a safety vent according to the present invention;

FIG. 3a is a cross section showing another rechargeable battery allowing replenishment of electrolytes of the present invention;

FIG. 3b is a perspective diagram showing a safety vent according to the present invention.

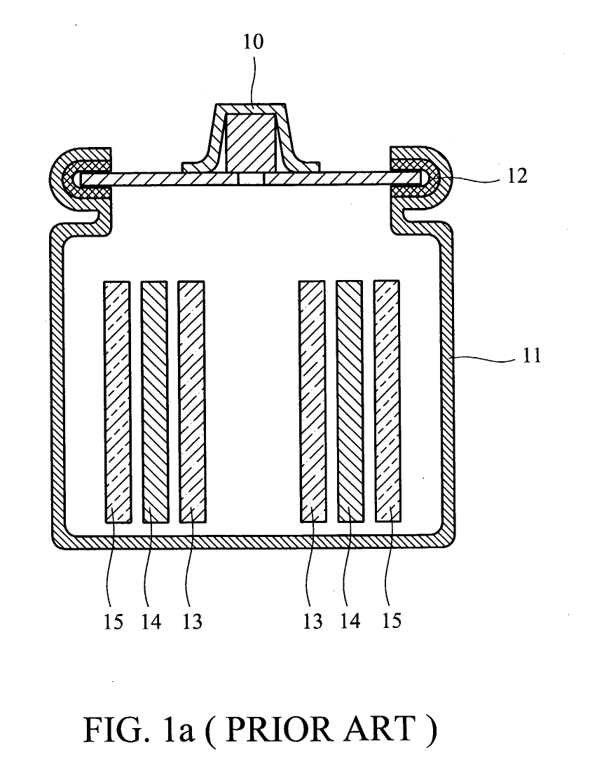

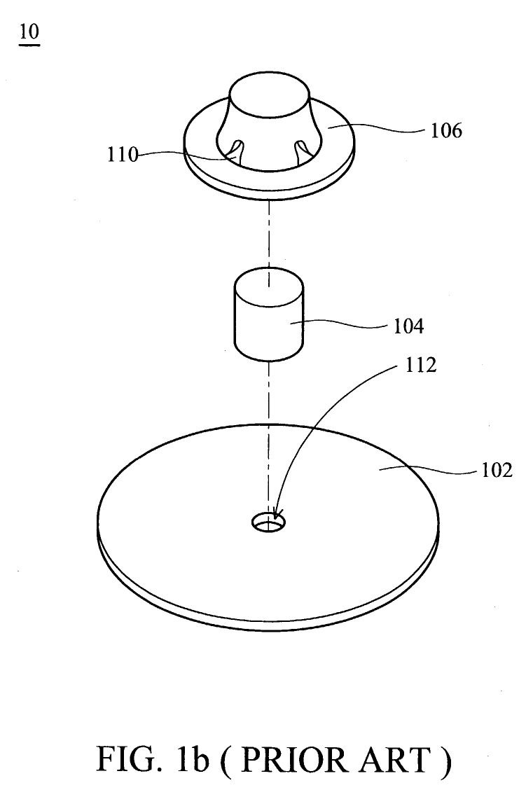

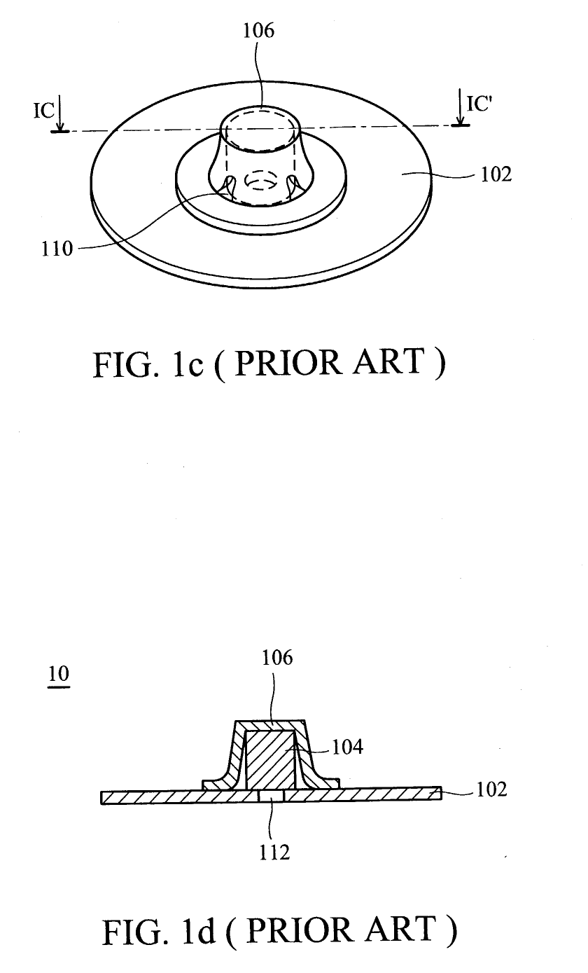

### DETAILED DESCRIPTION OF THE INVENTION

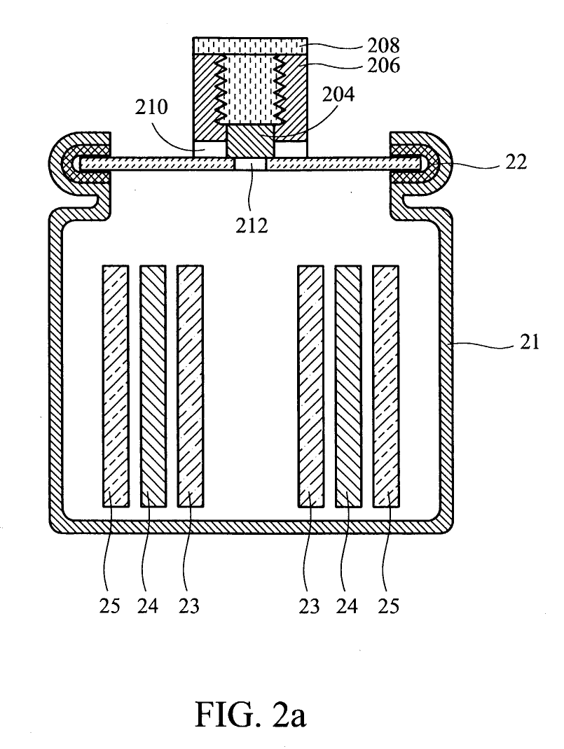

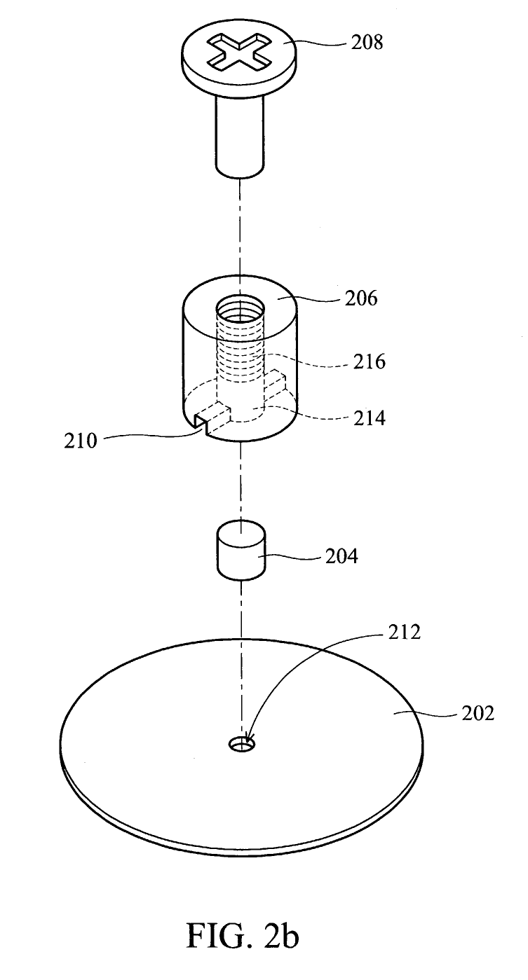

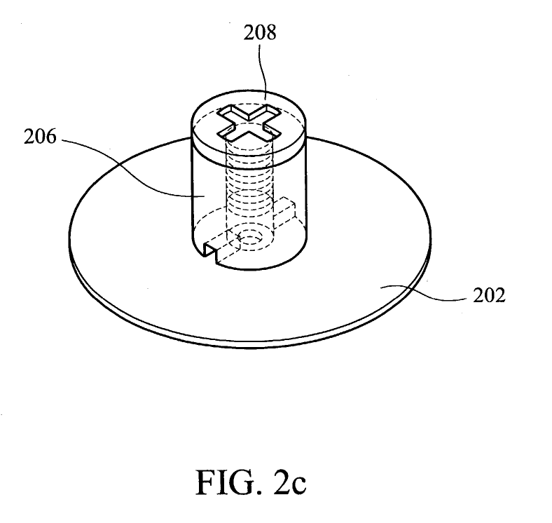

FIG. 2a to FIG. 2c depicts a first embodiment of a rechargeable battery allowing replenishment of electrolytes. FIG. 2a is a cross section showing the rechargeable battery according to the present invention; FIG. 2b is a perspective exploded diagram showing a safety vent according to the present invention; FIG. 2c is a perspective diagram showing the safety vent according to the present invention.

The rechargeable battery of the first embodiment allowing replenishment of electrolytes comprises a metal jacket 21, a positive electrode 23, a negative electrode 25, a cover 202, a base 206, a sealing member 204, and a compressing member 208. The cover 202, the base 206, the sealing member 204, and the compressing member 208 form a safety vent for the rechargeable battery according to the present invention. The metal jacket 21 has electrolytes therein. The positive electrode 23 and the negative electrode 25 are both disposed in the metal jacket 21 and immersed in the electrolytes. The cover 202 has an opening 212 and connects to the metal jacket 21. An insulating gasket 22 is disposed between the cover 202 and the metal jacket 21. The cover 202 and the metal jacket 21 enclose the positive electrode 23 and the negative electrode 25, and the base 206 connects to the other side of the cover 202. The base 206 has a through-hole and an exhaust passage 210 communicating therewith, and the through-hole communicates with the opening 212 of the cover 202. The sealing member 204 and the compressing member 208 are both disposed in the through-hole. The compressing member 208 presses the sealing member 204 to seal the opening 212 of the cover 202.

When the electrolytes in the rechargeable battery of the present invention are dissipated, the compressing member 208 is withdrawn such that the sealing member 204 is relaxed, allowing refill of the electrolytes through the opening 212 of the cover 202. The sealing member 204 then enters the through-hole of the base 206, and the compressing member 208 connects to the base 206. As a result, the chemical reaction takes place again, and lifetime of the battery is extended.

In an example, the through-hole of the body 206 mentioned above is a threaded opening, and the compressing member 208 is a screw. When the compressing member 208 connects to the body 206, the screw engages with the threaded opening.

Moreover, the sealing member 204 is made of rubber.

The body 206 and the cover 202 mentioned above are connected by welding.

In another example, the through-hole mentioned comprises an opening 214 and a threaded opening 216. The opening 214 and the threaded opening 216 are linked, and the opening 214 communicates with the opening 212 of the cover 202. The sealing member 204 is disposed in the opening 214, and the compressing member 208 is a screw engaged with the threaded opening 216.

Furthermore, a dividing plate 24 is disposed between the positive electrode 23 and the negative electrode 25. The positive electrode 23, the dividing plate 24, and the negative electrode 25 are cylindrical and coaxially arranged within the metal jacket 21.

Therefore, an advantage of the present invention is that the electrolytes can be repeatedly replenished if the electrolytes in the battery completely dissipate. Thus, the chemical reaction takes place again to extend the lifetime of the battery.

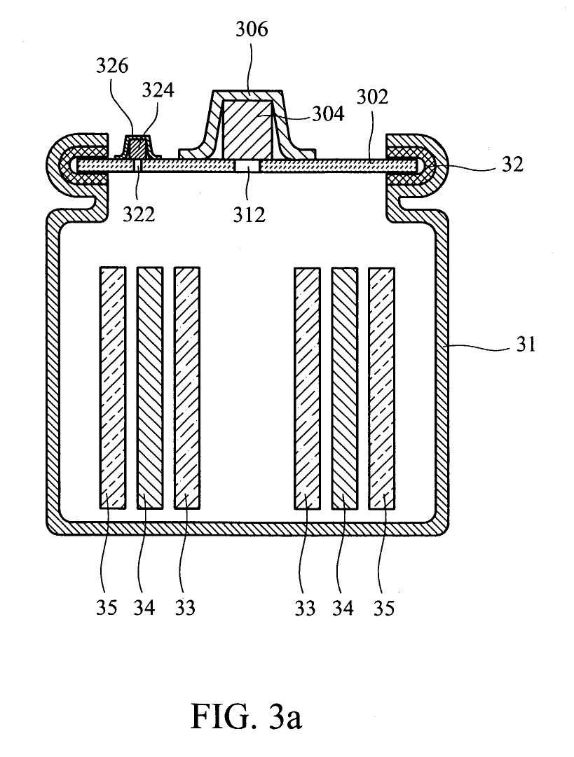

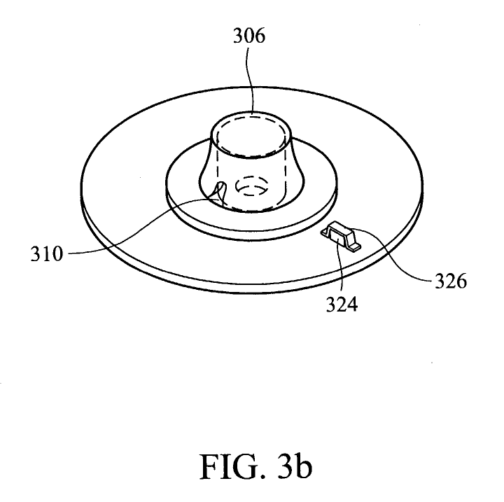

FIG. 3a and FIG. 3b depict a second embodiment of a rechargeable battery allowing replenishment of electrolytes.

The rechargeable battery of the third embodiment allowing replenishment of electrolytes comprises a metal jacket 31, a positive electrode 33, a negative electrode 35, a cover 302, a base 306, a first sealing member 304, a second sealing member 324 and a fastener 326. The cover 302, the base 306, the first sealing member 304, the second sealing member 324 and the fastener 326 form a safety vent of the rechargeable battery according to the present invention. The metal jacket 31 has electrolytes therein. The positive electrode 33 and the negative electrode 35 are both disposed in the metal jacket 31 and immersed in the electrolytes. The cover 302 has a first opening 312 and a second opening 322 and connects to the metal jacket 31. An insulating gasket 32 is disposed between the cover 302 and the metal jacket 31. The cover 302 and the metal jacket 31 enclose the positive electrode 33 and the negative electrode 35, and the base 306 connects to the other side of the cover 302. The base has an opening and an exhaust passage 310 communicating therewith, and the opening communicates with the first opening 312. The first sealing member 304 is disposed in the opening. By means of the pressure between the body 306 and the cover 302, the first sealing member 304 seals the first opening 312 of the cover 302. The fastener 326 connects to the cover 302 and fixes the second sealing member 324 to seal the second opening 322 of the cover 302.

When the electrolytes in the rechargeable battery of the present invention are dissipated, the fastener 326 is removed from the cover 302, and the second sealing member 324 is removed to refill the electrolytes from the second opening 322 of the cover 302. Another fastener 326 then holds the second sealing member 324 and is connected to the cover 302 by welding. By means of the pressure of the fastener 326, the second sealing member 324 seals the second opening 322 of the cover 302. As a result, chemical reactions take place again in the battery, and lifetime of the battery is extended.

Moreover, the first sealing member 304 and the second sealing member 324 mentioned above are made of rubber.

The body 306 and the cover 302 mentioned above are connected by welding, as are fastener 326 and the cover 302.

Furthermore, a dividing plate 34 is disposed between the positive electrode 33 and the negative electrode 35. The positive electrode 33, the dividing plate 34 and the negative electrode 35 are cylindrical and coaxially arranged within the metal jacket 31.

Therefore, an advantage of the present invention is that the electrolytes can be repeatedly replenished if the electrolytes in the battery completely dissipate. Thus, the chemical reaction takes place again to extend the lifetime of the battery.

Finally, while the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A rechargeable battery allowing replenishment of electrolytes, comprising:
a metal jacket having electrolytes therein;
a positive electrode disposed in the metal jacket and immersed in the electrolytes;
a negative electrode disposed in the metal jacket and immersed in the electrolytes;
a cover having an opening and connected to the metal jacket, wherein the cover and the metal jacket enclose the positive electrode and the negative electrode;
a base having a through-hole and an exhaust communicating therewith, wherein the through-hole communicates with the opening of the cover;
a sealing member disposed in the through-hole; and
a compressing member disposed in the through-hole, wherein the compressing member presses the sealing member to seal the opening of the cover.

2. The rechargeable battery allowing replenishment of electrolytes as claimed in claim 1, wherein the through-hole is a threaded opening and the compressing member is a screw engaged with the threaded opening.

3. The rechargeable battery allowing replenishment of electrolytes as claimed in claim 1, wherein the sealing member is made of rubber.

4. The rechargeable battery allowing replenishment of electrolytes as claimed in claim 1, wherein the base and the cover are connected by welding.

5. A rechargeable battery allowing replenishment of electrolytes, comprising:
a metal jacket having electrolytes therein;
a positive electrode disposed in the metal jacket and immersed in the electrolytes;
a negative electrode disposed in the metal jacket and immersed in the electrolytes;
a cover having an opening and connected to the metal jacket, wherein the cover and metal jacket enclose the positive electrode and the negative electrode;
a base having an opening, a threaded opening and an exhaust passage and connected to the cover, wherein the opening communicates with the opening of the cover, the threaded opening and the exhaust passage;
a sealing member disposed in the opening; and
a screw engaged with the threaded opening of the base, wherein the screw compresses the sealing member to seal the opening of the cover.

6. The rechargeable battery allowing replenishment of electrolytes as claimed in claim 5, wherein the sealing member is made of rubber.

7. The rechargeable battery allowing replenishment of electrolytes as claimed in claim 5, wherein the base and the cover are connected by welding.

8. A rechargeable battery allowing replenishment of electrolytes, comprising:
a metal jacket having electrolytes therein;
a positive electrode disposed in the metal jacket and immersed in the electrolytes;
a negative electrode disposed in the metal jacket and immersed in the electrolytes;
a cover having a first and second opening and connected to the metal jacket, wherein the cover and the metal jacket enclose the positive electrode and the negative electrode;
a base having an opening and an exhaust communicating therewith and connected to the cover, wherein the opening communicates with the first opening;
a first sealing member disposed in the opening to seal the first opening;
a second sealing member; and
a fastener connected to the cover, wherein the fastener fixes the second sealing member to seal the second opening of the cover.

9. The rechargeable battery allowing replenishment of electrolytes as claimed in claim 8, wherein the first and the second sealing member are made of rubber.

10. The rechargeable battery allowing replenishment of electrolytes as claimed in claim 8, wherein the base and the cover are connected by welding, and the fastener and the cover are connected by welding.

11. A safety vent for a rechargeable battery, comprising:
a cover having an opening;
a base having a through-hole and an exhaust communicating therewith and connected to the cover, wherein the through-hole communicates with the opening of the cover;
a sealing member disposed in the through-hole; and
a compressing member disposed in the through-hole, wherein the compressing member presses the sealing member to seal the opening of the cover.

12. The safety vent as claimed in claim 11, wherein the through-hole is a threaded opening and the compressing member is a screw engaged with the threaded opening.

13. The safety vent as claimed in claim 11, wherein the sealing member is made of rubber.

14. The safety vent as claimed in claim 11, wherein the base and the cover are connected by welding.

15. A safety vent for a rechargeable battery, comprising:
a cover having an opening;
a base having an opening, a threaded opening and an exhaust passage and connected to the cover, wherein the opening communicates with the opening of the cover, the threaded opening and the exhaust passage;
a sealing member disposed in the through-hole; and
a screw engaged with the threaded opening of the base, wherein the screw compresses the sealing member to seal the opening of the cover.

16. The safety vent as claimed in claim 15, wherein the sealing member is made of rubber.

17. The safety vent as claimed in claim 15, wherein the base and the cover are connected by welding.

18. A safety vent for a rechargeable battery, comprising:
a cover having a first and second opening;
a base having an opening and an exhaust communicating therewith and connected to the cover, wherein the opening communicates with the first opening;
a first sealing member disposed in the opening to seal the first opening;
a second sealing member; and
a fastener connected to the cover, wherein the fastener fixes the second sealing member to seal the second opening of the cover.

19. The safety vent as claimed in claim 18, wherein the first and the second sealing member are made of rubber.

20. The safety vent as claimed in claim 18, wherein the base and the cover are connected by welding, and the fastener and the cover are connected by welding.
